(19) United States
(12) Patent Application Publication
(10) Pub. No.: US 2007/0106599 A1
(43) Pub. Date: May 10, 2007

(54) Method and apparatus for dynamic risk assessment

(75) Inventors: Alon Hochberg, Ramat Aviv (IL); Vladimir Morgenstern, Framingham, MA (US)

Correspondence Address: DAVIDSON, DAVIDSON & KAPPEL, LLC, 485 SEVENTH AVENUE, 14TH FLOOR, NEW YORK, NY, 10018, US

(73) Assignee: Prolify Ltd., Netanya (IL)

(21) Appl. No.: 11/268,368

(22) Filed: Nov. 7, 2005

(51) Int. Cl. G06Q 40/00

(52) U.S. Cl. 705/38

(57) ABSTRACT

A method and apparatus for assessing at least one aggregate risk associated with an at least one first task associated with an at least one project, reducing said aggregate risk or alerting about said aggregate risk, the method comprising the steps of: determining a partial risk associated with said task; determining an aggregate risk associated with said task; comparing said aggregate risk a threshold; and wherein said total risk exceeds said threshold, performing at least one action. The method is executed dynamically as a response to on-going events occurring in the project. The actions taken can be notifications, inquiries and corrective actions.

### BACKGROUND OF THE INVENTION

1. Field of the Invention

The present invention relates to process planning and management in general and to a method for dynamically analyzing risks in processes, in particular.

2. Discussion of the Related Art

One of the most, if not the most important aspect of project or process management, is risk management. Some risks, such as insufficient resources, are evident at the time a process or a task within a process is established, other risks can be expected with certain likelihood, while yet others are unexpected and present themselves during execution of the task or of related tasks. However, risk assessment is usually executed only in relation to predetermined factors, and only when a process or a task is established or at predefined check-points. This has several undesired effects. First, a problem can be identified only at a later time than when it could have been identified, thus losing precious time that could be used for correcting the situation. Second, the risk identification is limited in scope to the type of problems and risks predicted by the task creator, and third, there is no structured destination for the alert message or notification. Therefore, the information about an existing or possible risk might exist, but it is often dispersed among different entities that do not have a view of the whole picture, or not at the appropriate levels for taking corrective actions. Yet another drawback, is that sometimes even a simple corrective action, taken early enough can reduce or altogether remove a risk, but if there is no person or automatic process to initiate such action, the opportunity is lost, and the problem worsens or a greater risk is generated.

There is therefore a need in the art for an automatic apparatus and method that will enable risk management as a major factor in establishing and managing processes or tasks. The risk assessment should be performed continuously and dynamically and be responsive to occurring events as well as available resources. The apparatus should be able to carry out corrective actions whenever possible, and alert the relevant functionary.

The risk assessment and taken actions should take into account various factors, related to the process, the process type, the risk type, severity, and timing within the process.

### SUMMARY OF THE PRESENT INVENTION

It is an object of the present invention to provide a novel method for detecting performance deficiencies of an operational environment, which overcomes the disadvantages of the prior art.

In accordance with the present invention, there is thus provided a method for determining one ore more aggregate risks associated with one ore more first tasks associated with one ore more projects, reducing said aggregate risk or alerting about said aggregate risk, the method comprising the steps of: determining one ore more partial risks associated with said first task; determining an aggregate risk associated with said first task; comparing said aggregate risk to one ore more thresholds; and wherein said total risk exceeds said threshold, performing one ore more actions. The method can be executed dynamically or in response to occurring events or in response to reported events. The method can be executed for tasks associated with the first task. The action can be issuing an alert to a person or a group of persons or one or more persons selected from a list. Within the method the action can be issuing an inquiry to a person or a group of persons or one or more persons selected from a list, or the action can be a corrective action, including sending a document to a person or advising a user on a best practice. Within the method, the partial risk is a function of a probability associated with the risk and an impact associated with the risk. The partial risk can be a quality risk, a user-specific risk or a schedule risk. The schedule risk can have an impact related to proximity between a start date and an end date associated with the first task and a critical path. Within the method, the partial risk determination step is performed for one ore more known risk patterns. The aggregate risk can be based on the partial risk.

Another aspect of the present invention relates to an apparatus for assessing one ore more aggregate risks associated with one ore more first tasks associated with one ore more projects, reducing said aggregate risk or alerting about said aggregate risk, the apparatus comprising: one ore more partial risk determination components, one ore more aggregate risk determination components, one ore more activity and destination selection components, and one ore more activity components. The activity component can be a document handling component, an inquiry or notification component, or a task update component. The project can be implemented as a graph. The apparatus further comprise graph manipulation components.

### BRIEF DESCRIPTION OF THE DRAWINGS

The present invention will be understood and appreciated more fully from the following detailed description taken in conjunction with the drawings in which:

FIG. 1 is an exemplary environment in which the disclosed apparatus is used;

FIG. 2 is a flowchart showing the main steps of the disclosed method;

FIG. 3 is a flowchart showing the main steps associated with determining a project risk, in accordance with a preferred embodiment of the disclosed invention; and

FIG. 4 is a block diagram showing the main components in the proposed apparatus, in accordance with a preferred embodiment of the disclosed invention.

### DETAILED DESCRIPTION OF THE PREFERRED EMBODIMENT

The present invention overcomes the disadvantages of the prior art by providing a novel method and a system for process definition, management and tracking using risk analysis as a major tool.

The disclosed invention provides for dynamic risk analysis, reduction, prevention or recovery, which is executed throughout the execution of a process. Dynamic risk analysis means that risk analysis is performed any time an activity occurs or when an activity occurrence is reported within the process, thus providing the dynamic response to on-going and possibly unexpected events, and not just to predicted events or as a result of scheduled assessment points. Each risk is optionally analyzed for a specific task the activity relates to, and recursively for all other tasks that can be influenced. Additionally, analyses are also performed at the creation time of projects or tasks to alert from inherent risks, such as insufficient resources, and at predetermined or dynamically determined times or intervals, so as to respond to activities that should have been reported or completed but were not. The analyzed risks are compared against one or more thresholds. If the risk is lower than any threshold, it is ignored. If the risk is beyond one ore more predetermined thresholds, one or more appropriate corrective actions are attempted, and beyond that one or more notifications are sent to relevant functionaries, not necessarily involved with any of the tasks.

One preferred embodiment in which the disclosed invention is used, involves implementing a project as a graph, comprising entities including people, tasks and documents as nodes, and relations between the above entities as edges. In this embodiment, each task is presented as a sub-graph involving the relevant entities, which is possibly connected to other parts of the graph. Each task, such as updating a document, is represented as a sub-graph of a specific pattern, and is added to the graph of a project when the task is established. Once a task is updated or created, i.e. added to a graph, additional tasks represented by patterns may have to be added (for example in conditional states, such as “if task A was accomplished, create and initiate a quality assurance task”). The system then searches for patterns created by the addition of patterns, and possibly adds one or more sub-graphs. This process can go on for a number of iterations. Upon each addition to the graph, risks associated with the updated tasks are assessed. Once the graph is stabilized, or after a predetermined number of iterations, the impact, i.e. all the additions to the graph are determined and the totals risk to the project are assessed. The graph embodiment utilizes graph theory calculations to determine risks associated with a task and further, possible recursive risks associated with affected tasks. The graph embodiment is described in details in International Patent Application serial number PCT/IL2005/000833, titled APPARATUS AND METHODS FOR PROCESS AND PROJECT MANAGEMENT AND CONTROL, assigned to Prolify Ltd., the whole contents of which is incorporated herein by reference. The risk level associated with each task takes into account the relevant factors, such as timely start, timely completion, required inputs, expected outputs and effects and others. In addition, the system attempts to identify and resolve inconsistent situations, such as completion of a task by a person other than the person to whom the task was assigned, two people having different versions of the same document, and the like. The risk assessment is performed over the map representation, and translated to activities, notifications and the like. The handled risk factors are roughly divided into four types. The first type relates to missing or inconsistent information, such as lack of report concerning the completion of a task, or contradicting reports about completion of a task from two or more users. The second type relates to different versions of one or more documents, being used by different versions. The third type is related to deviation from best practices, which often goes unnoticed. For example, if a task started later than scheduled, but ended on time, this could look like a handled situation, because further delay is avoided, but the situation can also lead to the task being executed with inferior quality due to the shortened execution time. The best practices can relate to resources such as time, human resources, equipment, money or others. The fourth type is risk patterns specific to an organization or organization type, such as whether conditions in a seasonal business or the like.

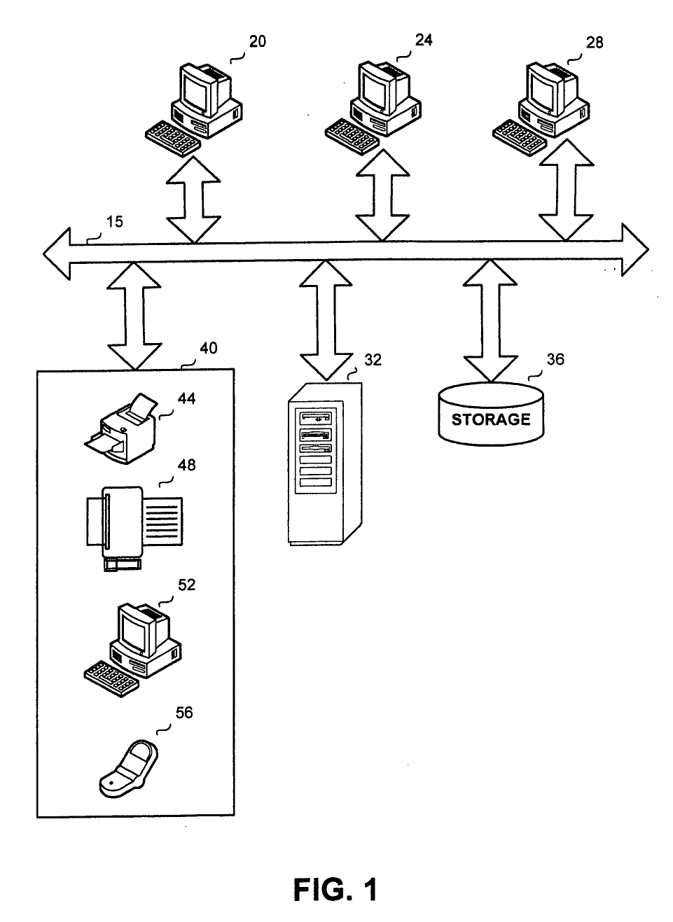

Referring now to FIG. 1, showing a typical environment in which the disclosed apparatus is used. A typical environment is an organization, employing multiple workers and performing multiple-person projects, such as developing new products, leading an organizational change, and the like. The typical computational environment of such organization comprises, similarly to any typical organization a network 15, multiple work stations 20, 24, 28, each work station being used by one or more users, and additional components used by almost any organization, such as one or more mail servers, backup servers or the like. Preferably, the environment further comprises a server 32 and a storage unit 36. In addition, the environment comprises one or more general-purpose or specific devices for receiving an alert when a risk level assessed by the system exceeds a predetermined threshold. The general-purpose devices can include, but are not limited to a printer to which notifications can be sent, a fax machine 44, a computer 52 able of receiving e-mails or otherwise being notified, a cellular phone 56 receiving either vocal or textual messages, and the like. The disclosed invention is preferably implemented as a client-server solution, wherein the client part, including a user interface, is executed by workstations 20, 24, 28 and others, and the server part is executed on server 32. Workstations 20,24, 28, and server 32 are preferably computing platforms such as a personal computer, a mainframe computer, or any other type of computing platform that is provisioned with a memory device (not shown), a CPU or microprocessor device, and several I/O ports (not shown). Alternatively, the server can be a DSP chip, an ASIC device storing the commands and data necessary to execute the methods of the present invention, or the like. Workstations 20, 24, 28, and server 32 can further include a storage device (not shown), storing the relevant applications. The applications are sets of logically inter-related computer programs and associated data structures that interact to detect, reduce or notify about risks. The methods of the disclosed invention are flexible, the relevant can be split in various ways between the server and the clients, the server's tasks can be distributed among two or more servers, and additional variations are possible. Storage unit 36, storing the data relevant to the organization can be a part of server 32, of any one or more of workstations 20, 24 or 28, a dedicated storage device or a general purpose storage device used for other purposes as well. The storage device can be magnetic tape, a magnetic disc, an optical disc, a laser disc, a mass-storage device, or the like.

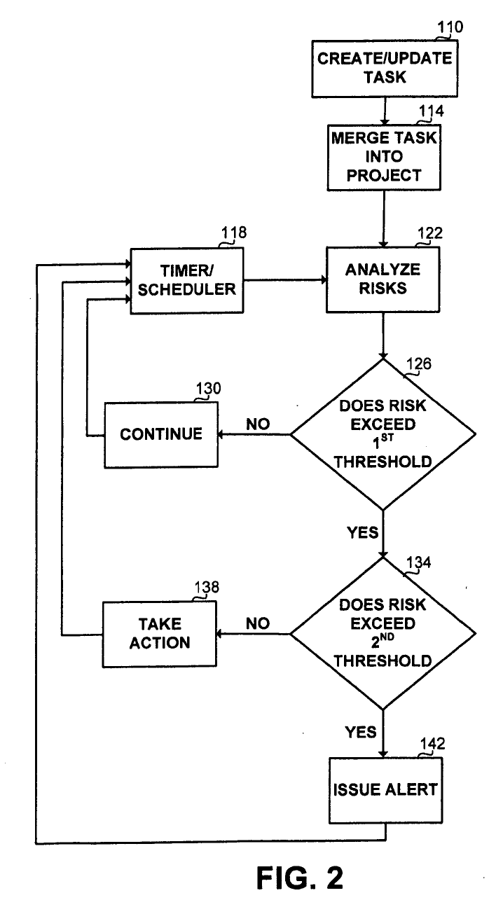

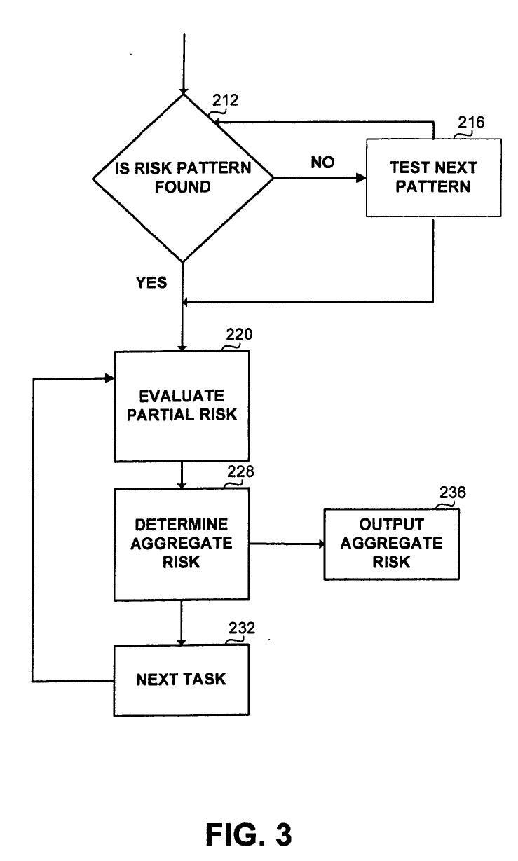

Referring now to FIG. 2, showing the main steps executed in association with the disclosed invention. At step 110, a task is created or updated by a user, or by an automated process. A user-created task can be to create or update a document, to initiate a new project or sub-project, to update a project or sub-project, or the like. A task update can be initiated, for example due to a user reporting the completion of a first task, which causes the update of the state of a second task depending on the output of the first task. The chain of events initiated by the task provides the dynamic nature of the risk management, and enables the on going risk assessment as evolving over time and activities, and the timely notification, activities and updating of the project map. At step 114, the task is inserted into an existing or a newly-created project graph, and at step 122 the system analyzes the aggregate risks relevant to the project, which is the affected by all relevant tasks. The aggregate risk analysis is detailed in association with FIG. 3 below. Alternatively, or in addition, the system performs project-wide risk analysis at predetermined times or time intervals, as initiated by the system at step 118. The system-initiated risk analyses can reveal, for example, tasks not completed at the expected date. Then, at step 126 each detected risk is compared against a first threshold. If the risk is below the threshold, it is ignored or a note is taken in a log file or another logging mechanism for future reference at step 130, but no user is notified and no action is taken. This is done so as to limit the number of notifications and avoid a multiplicity of false alarms which will eventually cause users to distrust notifications issued by the system and ignore them. If the risk level exceeds a first threshold, it generally causes an action, such as creation or updating of a task or another entity in the system. The action type and destination depends on the risk type and on its intensity. For example, the risk level can be compared against a second threshold at step 134. If the risk level is below the second threshold, an action can be attempted at step 138, if applicable. Such action can be, for example sending an e-mail to a user containing an inquiry, an updated version of a file, or a request to resolve a situation of two versions of a file, to acknowledge the report of a completion of a task by the wrong person or the like. It will be appreciated that more than two thresholds can be used, such that different actions are related to different thresholds. If the risk level exceeds the second, or another threshold, a notification or alert is issued to a relevant functionary in step 142. The alert can be an SMS message, an e-mail sent, a document being printed, a multimedia message, a fax sent or any other notification message as determined by a user. It is also possible to define multiple thresholds, such that notifications are sent to one or more persons or groups of persons as a function of the risk level. It will be appreciated by people skilled in the art that the two comparison and actions presented are exemplary only, and that more or less comparisons can be performed, and that zero, one, or more actions or notifications can be taken if any of the thresholds is exceeded.

Referring now to FIG. 3, showing the main steps associated with determining a project risk, referred to as step 122 of FIG. 2. The system traverses all risk patterns existing in the system to see if the risk is present within the updated project map, containing the added or updated task. The impact map, i.e. the area of the project map affected by task update, is scanned at step 212. During the scanning, instances of the i-th risk pattern are identified, where i goes from 1 to the number of risk patterns stored in the system. The system examines whether the risk pattern is to be found within the updated project map containing the added task. The risk examination step comprises comparing the required parameters associated with a risk to the actual parameters, wherein the parameters can be execution duration, completion date, required outputs, and additional factors such as completion of a task by the person the task was assigned to, contradictions such as duplicate report of completion of a task, different versions of a document and the like. The method of determining the associated risk is detailed below. If the i-th risk pattern is not to be found within the graph, the system goes on at step 216 to test the next risk pattern. If the risk pattern is found, the system then traverses all the tasks dependent on the specific risk. For example, if the specific risk is late completion of a certain task, the dependent tasks are all tasks that require as inputs the outputs of the specific tasks or otherwise dependent on the task's completion. At step 220, the system evaluates the partial risk level associated with risk pattern i imposes on dependent task j where j goes from 0 being the root task associated with the risk, to the number of tasks dependent on the i-th risk. At step 228 the system determines the aggregate risk associated with task j, by combining compatible risks (for example, all delay risk are defined by their probability and the extent of the delay, while quality risk are simply added up) The aggregate risk is output at step 236, and is considered against the first threshold as described in association with step 126 of FIG. 2 above. The system then goes on to evaluate the risks for the next task dependent on risk i. For each risk type, the risk level is estimated as a function, such as multiplication, of the risk's probability and the risk's impact. The probability and the impact associated with each risk are defined at one of the levels of: risk, task type, project, or task, and has possible values of low, medium or high. Existing risk levels include, but are not limited to, quality risk level, schedule risk level and user-specific risk level. User-specific risk levels include the definition of new risk levels associated with specific reactions, or the setting of different risk tolerances for existing risk levels. The quality risk level is a function of quality probability and quality impact, wherein the quality probability is the probability of influencing the project's quality and is defined at the risk level, and the quality impact is the impact on quality and is defined at the task-type level. Preferably, both the quality probability and the quality impact can have values of High, Medium or Low, although finer or coarser scales can also be implemented. The schedule risk level is a function of schedule probability and schedule impact, wherein the schedule probability is the probability of change in the task's schedule and is defined at the risk level, and the schedule impact is the potential impact on task schedule as affected by the new or estimated start date and the new or estimated end date, and is defined at the risk level. The risk impact on a task's schedule is determined by its proximity to the critical path as influenced by the updated expected start and end date of the task. For example, the start proximity can be determined as the interval between the actual start date of the task and the earliest possible start date, in relation to the interval between the latest start date and the earliest start date, and the same for the end date of the task. A formulation of the above is: Start proximity=(estimated start date-early start date)/(late start date-early start date), and similarly End proximity=(estimated end date-early end date)/(late end date-early end date). However, other functions connecting the expected, early and late dates can be implemented. The user-specific risk level, as calculated for each factor involved with the task, is a function of the weight of the task within the project, as defined either at the project, task type or task instance level, and specific key performance indicators. Such key performance indicators can be, for example the completion percentage of the task, relatively to the percentage of the task's resources (such as time or effort) already used. The total risk levels associated with a task depend on one ore more of the three factors detailed above, namely quality, schedule, and user levels, and optionally on additional ones. The activity taken at step 126 or at step 134 of FIG. 2 depends, as mentioned above on the risk type and risk level. The activities can include inquiries or notifications sent to people, automatic data completion, including arcs or attributes in the graph representation of project, or newly added tasks. For example, a low schedule risk level causes an inquiry to be sent to the task owner; a medium schedule risk level causes a notification to be sent to the manager of the task owner, while a high schedule risk level causes a notification to be sent to a project manager, a specific risk reaching a high level causes the sending of a new version of a document to a task owner, advising a user on an applicable best practice, or the like. The escalation conditions are generally the risk reaching the next level (after handling the risk, if necessary) at lower risk level, or a risk detected regarding predecessor activities. For example, a test case dealing with a creation if a task is presented. The task is a change request, whose input is a change request document and is assigned to a QA manager. The task is broken down to two sub-tasks, being the test planning and the test execution, both assigned to a QA tester, and whose input is the same document. Suppose the test plan is completed and the test execution started, when an updated change request document was published. The associated risks can be as follows: the update document not published to the QA manager. This risk can be handled by the system sending the updated document to the QA manager. Another associated risk is the updated document not reaching the QA tester, which is similarly resolved by the system sending the version to the QA tester. Yet another risk is that the QA tester did not acknowledge receipt of the new document, which is resolved, at least temporarily by the system sending an inquiry to the QA tester. Once the QA tester acknowledges receipt—the risk is removed. Yet another risk pattern is that the QA manager did not assign a new task, being updating the test plan according to the new change request, to the QA tester, as recommended by the organization's best practices. This s resolved by sending a notification to the QA manager. Another risk is that the test plan was updated, but the activity schedule was not updated, which is resolved by an inquiry to the QA tester, and another existing risk is that the newly created test plan implies a key performance indicator, being the test coverage being suboptimal, which is notified to functionaries according to the advancing time table.

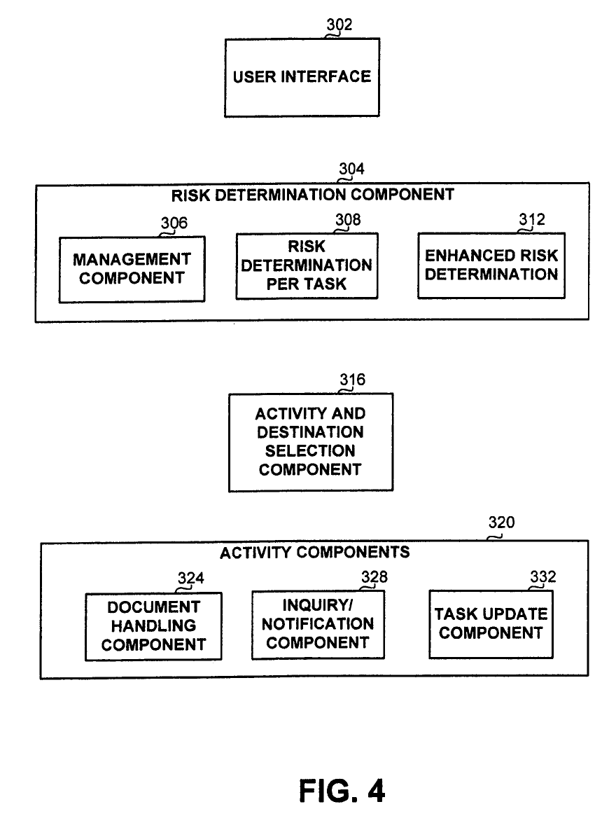

Reference is now made to FIG. 4, showing the main components in a preferred implementation of the proposed apparatus executing the proposed methods. The apparatus comprises the basic components and graph handling components, as described in International Patent Application serial number PCT/IL2005/000833, titled APPARATUS AND METHODS FOR PROCESS AND PROJECT MANAGEMENT AND CONTROL, assigned to the Prolify Ltd., the whole contents of which is incorporated herein by reference. The apparatus further comprises user interface components 302, risk determination components 304, which further comprise management component 306, responsible for the control flow of the risk assessment method as described in FIG. 2 and FIG. 3 above, risk determination component per task 308, performing the method associated with step 220 of FIG. 3 above, and aggregate risk determination component 312, executing step 228 of FIG. 3 above. The apparatus further comprises an activity and destination selection component 316, for selecting according to an existing risk type and level, the activity to be performed, such as notification, alert, action, or the like, and the destination, such as task owner, task owner's manager, CEO, a specifically named person or the like. Optionally, the apparatus further comprises activity components 320 for carrying out the activities and updating the project map accordingly. The components include document handling component 324, responsible for sending an updated version of the document to the persons associated with this document, once it is updated. Another activity component is a inquiry/notification component 328 which is preferably implemented by generating a message to be sent to a person, the message either inquiring him or her about the status of a task or a document, or notifying him or her about a situation, such as a high level risk. The apparatus further comprises a task update component 332, for adding or updating a task within the project map, as a result of an identified risk or an activity. When the disclosed method is indeed implemented in a graph, graph manipulation components are comprised in the embodiment, for traversing risks, finding risk patterns within a graph, adding sub-tasks represented as sub-graphs and the like.

People skilled in the art will appreciate that additional risk levels and additional risk factors influencing the presented risk levels may exist, for example the proximity of a risk to the beginning of a project, wherein the closer the risk to the beginning of the project, the higher its potential damage, the influence of conditions not related to the organization, and others. It will also be appreciated that various ways of assessing risks associated with one or more tasks may exist, and various ways of combining different risk levels may exist. In addition, the examples presented above for system-initiated activities are merely examples and various different activities can be implemented.

It will be appreciated by persons skilled in the art that the present invention is not limited to what has been particularly shown and described hereinabove. Rather the scope of the present invention is defined only by the claims which follow.

I/we claim:

1. A method for determining at least one aggregate risk associated with an at least one first task associated with an at least one project, reducing said aggregate risk or alerting about said aggregate risk, the method comprising the steps of:
determining an at least one partial risk associated with said first task;
determining an aggregate risk associated with said first task;
comparing said aggregate risk to an at least one threshold; and
wherein said total risk exceeds said threshold, performing at least one action.

2. The method of claim 1 wherein the method is executed dynamically.

3. The method of claim 1 wherein the method is executed in response to occurring events.

4. The method of claim 1 wherein the method is executed in response to reported events.

5. The method of claim 1 wherein the method is executed for tasks associated with the at least one first task.

6. The method of claim 1 wherein the action is issuing an alert to a person or a group of persons or one or more persons selected from a list.

7. The method of claim 1 wherein the action is issuing an inquiry to a person or a group of persons or one or more persons selected form a list.

8. The method of claim 1 wherein the action is a corrective action.

9. The method of claim 8 wherein the corrective action is sending a document to a person.

10. The method of claim 8 wherein the corrective action is advising a user on a best practice.

11. The method of claim 1 wherein the partial risk is a function of a probability associated with said risk and an impact associated with said risk.

12. The method of claim 1 wherein the partial risk is a quality risk.

13. The method of claim 1 wherein the partial risk is a user-specific risk.

14. The method of claim 1 wherein the partial risk is a schedule risk.

15. The method of claim 14 wherein the schedule risk has an impact related to proximity between an at least one start date and at least one end date associated with the first task and a critical path.

16. The method of claim 1 wherein the partial risk determination step is performed for an at least one known risk pattern.

17. The method of claim 1 wherein the aggregate risk is based on the at least one partial risk.

18. An apparatus for assessing at least one aggregate risk associated with an at least one first task associated with an at least one project, reducing said total risk or alerting about said aggregate risk, the apparatus comprising:
an at least one partial risk determination component;
an at least one aggregate risk determination component;
an at least one activity and destination selection component; and
an at least one activity component.

19. The apparatus of claim 18 wherein the at least one activity component is a document handling component.

20. The apparatus of claim 18 wherein the at least one activity component is an inquiry or notification component.

21. The apparatus of claim 18 wherein the at least one activity component is a task update component.

22. The apparatus of claim 18 wherein the at least one project is implemented as a graph.

23. The apparatus of claim 22 further comprising graph manipulation components.
